(19) United States
(12) Patent Application Publication
(10) Pub. No.: US 2025/0135665 A1
(43) Pub. Date: May 1, 2025

(54) MULTI-BATTERY-EQUIPPED ROBOT

(71) Applicant: NINGBO POOLSTAR POOL PRODUCTS CO.,LTD., NINGBO (CN)

(72) Inventor: Liang CHEN, NINGBO (CN)

(21) Appl. No.: 19/008,020

(22) Filed: Jan. 2, 2025

(30) Foreign Application Priority Data
May 24, 2024 (CN) 202421155010.8

(51) Int. Cl. B25J 19/00; B25J 5/00; B25J 9/00; B25J 9/10

(52) U.S. Cl. CPC B25J 19/005; B25J 5/005; B25J 9/0009; B25J 9/102; B25J 19/0025

(57) ABSTRACT

A multi-battery-equipped robot includes a casing assembly, a control box provided within the casing assembly, a driving motor, a suction motor and at least two battery assemblies. The driving motor is detachably provided on an inner wall of the casing assembly. The suction motor is detachably provided on an inner bottom surface of the casing assembly. Each battery assembly includes a battery pack and a circuit board. An outer wall of the casing assembly is provided with a slot, in which the battery assemblies are detachably provided. The battery pack is electrically connected to the circuit board through a first cable. The circuit board is electrically connected to the control box through a second cable. Any two circuit boards are electrically connected to each other through a third cable.

### CROSS-REFERENCE TO RELATED APPLICATIONS

This application claims the benefit of priority from Chinese Patent Application No. 202421155010.8, filed on May 24, 2024. The content of the aforementioned application, including any intervening amendments made thereto, is incorporated herein by reference in its entirety.

### TECHNICAL FIELD

This application relates to robotic technologies, and more particularly to a multi-battery-equipped robot.

### BACKGROUND

Most of the existing multi-battery-equipped robots rely on a single rechargeable battery to supply power. However, this design will greatly affect the battery life, thereby shortening the operation duration of robots. In this regard, a novel multi-battery-equipped robot is developed to solve such problems.

### SUMMARY

In view of this, an object of the present disclosure is to provide a robot with a multi-battery structure to overcome the defects in the prior art.

A multi-battery-equipped robot, comprising:
a casing assembly;
a control box;
a driving motor;
a suction motor; and
at least two battery assemblies;
wherein the casing assembly comprises a first casing and a second casing connected with each other;
the control box is provided within the casing assembly;
the driving motor is detachably provided on an inner wall of the casing assembly, and the driving motor is electrically connected to the control box through a first cable;
the suction motor is detachably provided on an inner bottom surface of the casing assembly, and the suction motor is electrically connected to the control box through a second cable; and
each of the at least two battery assemblies comprises a battery pack and a circuit board; an outer wall of the casing assembly is provided with a first slot, and each of the at least two battery assemblies is detachably provided within the first slot; the battery pack is electrically connected to the circuit board through a third cable; the circuit board is electrically connected to the control box through a fourth cable; and any two of circuit boards of the at least two battery assemblies are electrically connected through a fifth cable.

In some embodiments, the first cable, the second cable, the third cable, the fourth cable and the fifth cable are each provided with a connector.

In some embodiments, the connector comprises a first plug and a second plug; the first plug is provided with a second slot fitting the second plug; and the second plug is insertedly connected with the second slot.

In some embodiments, a cover plate is provided at an opening of the first slot, and two opposite sides of the cover plate are movably connected to the first slot.

In some embodiments, one of the two opposite sides of the cover plate is hinged to a first edge of the opening of the first slot, and the other of the two opposite sides of the cover plate is in snap-fit connection with a second edge of the opening of the first slot.

In some embodiments, each of the at least two battery assemblies is provided with a charging plug, and the cover plate is provided with a charging port corresponding to the charging plug.

In some embodiments, two sides of the casing assembly are each provided with a moving mechanism, and the moving mechanism is configured to enable movement of the multi-battery-equipped robot.

In some embodiments, the moving mechanism comprises a caterpillar track; the two sides of the casing assembly are each provided with the caterpillar track; and the caterpillar track is drivably connected to the driving motor through a transmission assembly.

In some embodiments, the transmission assembly comprises a first gear and a second gear; the first gear is connected to an output end of the driving motor; the second gear is engaged with the first gear; and the second gear is configured to drive the caterpillar track to rotate.

Compared to the prior art, the present disclosure has the following beneficial effects.

Regarding the robot provided herein, multiple battery assemblies are provided within a slot, and each battery assembly is provided with a corresponding circuit board, such that the voltage of individual battery packs can be monitored in real time. The multiple battery packs can be connected in series for power supply, or one or more battery packs are selected to power the robot in parallel, effectively extending the operation time of the electric robot.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated in these drawings without making creative effort.

FIG. 1 schematically shows an overall structure of a multi-battery-equipped robot in accordance with an embodiment of the present disclosure;

FIG. 2 is a structural schematic diagram of a battery assembly of the robot in accordance with an embodiment of the present disclosure;

FIG. 3 schematically shows an internal structure of the robot in accordance with an embodiment of the present disclosure; and

FIG. 4 is a structural schematic diagram of a connector of the robot in accordance with an embodiment of the present disclosure.

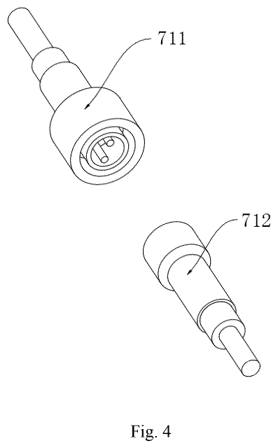

In the figures: 1—casing assembly; 11—first casing; 12—second casing; 13—first slot; 14—drain hole; 15—cover plate; 151—fastener; 152—charging port; 2—control box; 3—driving motor; 31—fixing ring; 4—suction motor; 5—battery assembly; 51—battery pack; 52—circuit board; 53—charging plug; 6—moving mechanism; 61—first gear; 62—second gear; 63—caterpillar track; 7—fourth cable; 71—connector; 711—first plug; and 712—second plug.

The implementation, functional characteristics, and advantages of the present disclosure will be further described in conjunction with the embodiments and the accompanying drawings.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

It should be noted that all directional indications (such as up, down, left, right, front, and back) in the embodiments of the present disclosure are used only for explaining the relative positional relationship or movement between the components in a particular attitude (as shown in the accompanying drawings), and the directional indications are correspondingly changed if the particular attitude is changed.

Furthermore, terms such as “first” and “second” are only descriptive, and should not be construed as indicating or implying their relative importance or implicitly specifying the number of technical features indicated. As a result, a feature defined as “first” or “second” may include at least one of such feature, either explicitly or implicitly. In addition, “and/or” includes three solutions, for example, “A and/or B” includes technical solution A, technical solution B, and a combination thereof. In addition, the technical solutions of various embodiments may be combined with each other on the premise that the combined solution can be implemented by those of ordinary skill in the art. When the combination of technical solutions appears to be contradictory or unimplementable, it should be understood that such a combination does not exist, and is not included within the scope of the present disclosure.

An electric robot provided herein is designed to operate in an underwater environment.

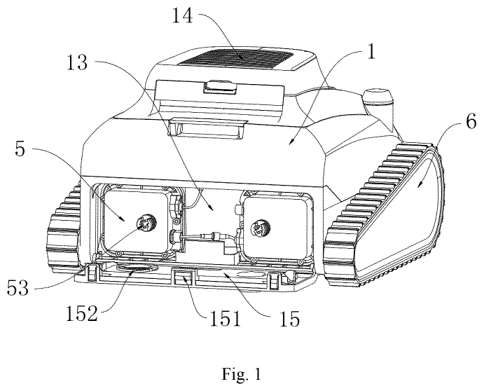

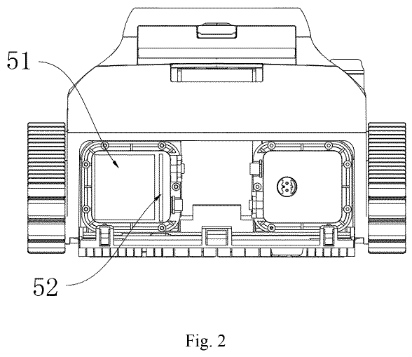

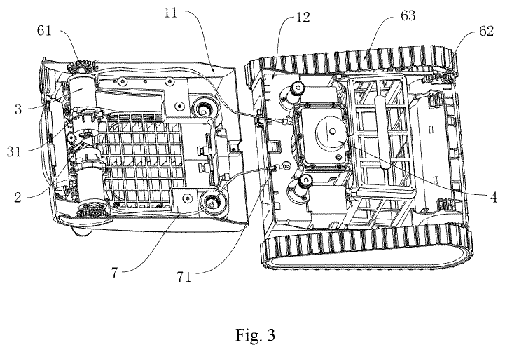

As shown in FIGS. 1-3, an embodiment of the present disclosure provides a multi-battery-equipped robot, including a casing assembly 1, a control box 2, a driving motor 3, a suction motor 4 and at least two battery assemblies 5. The casing assembly 1 includes a first casing 11 and a second casing 12 connected with each other. The control box 2 is provided on an inner wall of the first casing 11. The driving motor 3 is detachably provided on the inner wall of the first casing 11, and is arranged at the same end as the control box 2. The driving motor 3 is electrically connected to the control box 2 through a first cable. The suction motor 4 is detachably provided on an inner bottom surface of the second casing 12, and is arranged at an end away from the driving motor 3. The suction motor 4 is electrically connected to the control box 2 through a second cable. Each of the at least two battery assemblies 5 includes a battery pack 51 and a circuit board 52. An outer wall of the second casing 12 is provided with a first slot 13, and each of the at least two battery assemblies 5 is detachably provided within the first slot 13. The battery pack 51 is electrically connected to the circuit board 52 through a third cable. The circuit board 52 is electrically connected to the control box 2 through a fourth cable 7. Any two of circuit boards 52 of the at least two battery assemblies 5 are electrically connected through a fifth cable.

In this embodiment, the circuit board 52 can monitor the voltage of the corresponding battery pack 51 in real time, such that the power supply battery pack 51 can be flexibly selected based on the voltage. Meanwhile, under the control of the circuit board 52, multiple battery packs 51 can independently supply power to the multi-battery-equipped robot simultaneously, or they can be connected in series to provide continuous power to the multi-battery-equipped robot.

Regarding the robot provided herein, multiple battery assemblies 5 are provided within the first slot 13, and each battery assembly 5 is provided with a corresponding circuit board 52, such that the voltage of individual battery packs 51 can be monitored in real time. The multiple battery packs 51 can be connected in series for power supply, or one or more battery packs 51 are selected to power the robot in parallel, effectively extending the operation time of the electric robot.

In some embodiments, the number of the battery assembly 5 is two.

Control modules, such as the control box 2, the driving motor 3, the suction motor 4 and the battery assemblies 5 are arranged at different locations within the casing assembly 1 and connected through detachable connections, such that any faulty component can be easily detached for repair, simplifying the operation and improving maintenance efficiency.

In some embodiments, the number of the driving motor 3 is two.

In an embodiment, the first cable, the second cable, the third cable, the fourth cable 7 and the fifth cable are each provided with a connector 71.

In this embodiment, the connectors 71 provided on the cables mentioned above are designed to enable quick disconnection between the faulty component and other connected components during maintenance, such that the faulty component can be rapidly detached.

In an embodiment, the connector 71 includes a first plug 711 and a second plug 712. The first plug 711 is provided with a second slot fitting the second plug 712, and the second plug 712 is insertedly connected with the second slot.

In this embodiment, when the first plug 711 and the second plug 712 are separated, the power transmission between the cables is interrupted. After the second plug 712 is insertedly connected with the second slot, the first plug 711 and the second plug 712 are connected, allowing the power supply to the cables.

In an embodiment, a cover plate 15 is provided at an opening of the first slot 13, and two opposite sides of the cover plate 15 are movably connected to the first slot 13.

In this embodiment, the cover plate 15 is provided at the opening of the first slot 13 to protect the battery assemblies 5 inside the first slot 13. The cover plate 15 is movably connected to the first slot 13, allowing for easy maintenance or replacement in the case of failure of the battery pack 51.

In an embodiment, one of the two opposite sides of the cover plate 15 is hinged to a first edge of the opening of the first slot 13, and the other of the two opposite sides of the cover plate 15 is in snap-fit connection with a second edge of the opening of the first slot 13.

Based on the above design, the first slot 13 can be quickly opened in the case of failure of the battery pack 51, allowing for easy maintenance or replacement.

In an embodiment, each of the two battery assemblies 5 is provided with a charging plug 53. The cover plate 15 is provided with a charging port 152 corresponding to the charging plug 53.

In this embodiment, the provided charging plug 53 is configured to charge the battery assemblies 5.

In an embodiment, two sides of the casing assembly 1 are each provided with a moving mechanism 6 configured to enable movement of the multi-battery-equipped robot.

In this embodiment, by means of the moving mechanisms 6, the driving motor 3 is configured to drive the moving mechanisms 6 to operate, so as to drive the multi-battery-equipped robot to move in any direction.

In an embodiment, the moving mechanism 6 includes a caterpillar track 63. Two sides of the casing assembly 1 are each provided with the caterpillar track 63. The caterpillar track 63 is drivably connected to the driving motor 3 through a transmission assembly.

In this embodiment, during operation, the driving motor 3 drives the transmission assembly to operate, which in turn drives the caterpillar track 63 to rotate, causing the multi-battery-equipped robot to move.

In an embodiment, the transmission assembly includes a first gear 61 and a second gear 62. The first gear 61 is connected to an output end of the driving motor 3. The second gear 62 is engaged with the first gear 61. The second gear 62 is configured to drive the caterpillar track 63 to rotate.

In this embodiment, the driving motor 3 drives the first gear 61 to rotate, which in turn drives the second gear 62 to rotate. Then, the rotation of the second gear 62 drives the caterpillar track 63, causing the multi-battery-equipped robot to move.

In an embodiment, a top of the first casing 11 is provided with a plurality of drain holes 14.

In this embodiment, by means of the plurality of drain holes 14, the multi-battery-equipped robot can discharge the purified water.

Described above are merely preferred embodiments of the present disclosure, and are not intended to limit the scope of the present disclosure. Any equivalent structural changes made based on the description and the accompanying drawings of the present disclosure under the inventive concept of the present disclosure, or direct/indirect application in other related technical fields shall fall within the scope of the present disclosure defined by the appended claims.

What is claimed is:

1. A multi-battery-equipped robot, comprising:
a casing assembly;
a control box;
a driving motor;
a suction motor; and
at least two battery assemblies;
wherein the casing assembly comprises a first casing and a second casing connected with each other;
the control box is provided within the casing assembly;
the driving motor is detachably provided on an inner wall of the casing assembly, and the driving motor is electrically connected to the control box through a first cable;
the suction motor is detachably provided on an inner bottom surface of the casing assembly, and the suction motor is electrically connected to the control box through a second cable; and
each of the at least two battery assemblies comprises a battery pack and a circuit board; an outer wall of the casing assembly is provided with a first slot, and each of the at least two battery assemblies is detachably provided within the first slot; the battery pack is electrically connected to the circuit board through a third cable; the circuit board is electrically connected to the control box through a fourth cable; and any two of circuit boards of the at least two battery assemblies are electrically connected through a fifth cable.

2. The multi-battery-equipped robot of claim 1, wherein the first cable, the second cable, the third cable, the fourth cable and the fifth cable are each provided with a connector.

3. The multi-battery-equipped robot of claim 2, wherein the connector comprises a first plug and a second plug; the first plug is provided with a second slot fitting the second plug; and the second plug is insertedly connected with the second slot.

4. The multi-battery-equipped robot of claim 1, wherein a cover plate is provided at an opening of the first slot, and two opposite sides of the cover plate are movably connected to the first slot.

5. The multi-battery-equipped robot of claim 4, wherein one of the two opposite sides of the cover plate is hinged to a first edge of the opening of the first slot, and the other of the two opposite sides of the cover plate is in snap-fit connection with a second edge of the opening of the first slot.

6. The multi-battery-equipped robot of claim 4, wherein each of the at least two battery assemblies is provided with a charging plug, and the cover plate is provided with a charging port corresponding to the charging plug.

7. The multi-battery-equipped robot of claim 1, wherein two sides of the casing assembly are each provided with a moving mechanism, and the moving mechanism is configured to enable movement of the multi-battery-equipped robot.

8. The multi-battery-equipped robot of claim 7, wherein the moving mechanism comprises a caterpillar track; the two sides of the casing assembly are each provided with the caterpillar track; and the caterpillar track is drivably connected to the driving motor through a transmission assembly.

9. The multi-battery-equipped robot of claim 8, wherein the transmission assembly comprises a first gear and a second gear; the first gear is connected to an output end of the driving motor; the second gear is engaged with the first gear; and the second gear is configured to drive the caterpillar track to rotate.
